(19) United States
(12) Patent Application Publication
(10) Pub. No.: US 2009/0147996 A1
(43) Pub. Date: Jun. 11, 2009

(54) SAFE FOLLOWING DISTANCE WARNING SYSTEM AND METHOD FOR A VEHICLE

(75) Inventor: KUO-LIN PENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/057,725

(22) Filed: Mar. 28, 2008

(30) Foreign Application Priority Data
Dec. 10, 2007 (CN) 200710202955.5

(51) Int. Cl. G06K 9/00

(52) U.S. Cl. 382/106

(57) ABSTRACT

A safe following distance warning system for a vehicle includes a forward-looking image capturing unit, a speed sensor, a processor, and a warning output device. The forward-looking image capturing unit is for capturing images forward of the vehicle. The forward-looking image capturing unit includes a taking lens, an image sensor disposed behind the taking lens, an image processing unit, and a lens driving unit. The image processing unit is for calculating an in-focus position of the taking lens. The speed sensor is for sensing a current speed of the vehicle. The processor is for calculating a following distance from the vehicle to a vehicle directly forward of the vehicle and comparing the following distance to an applicable safe distance parameter. The warning output device is for outputting an alarm to the driver of the vehicle when the following distance is less than the applicable safe distance parameter.

### TECHNICAL FIELD

The present invention relates to safety systems for vehicles and, particularly, to a safe following distance warning system for a vehicle capable of timely alerting a driver when they are following a vehicle too closely.

### DESCRIPTION OF RELATED ART

Automobile accidents result in thousands of fatalities and injuries each year and cause millions of dollars in property damage in the world. Rear-end collisions, a type of automobile accident, are common because of a driver following another vehicle too closely.

In order to avoid a rear-end collision, a safe following distance warning system for a vehicle must accurately judge a speed of a vehicle and a distance to a vehicle it is following by using the system. Conventional safe following distance warning systems usually measure the distance between vehicles by use of a radar range finder, ultrasonic range finder, microwave range finder and so on. All of these range finders are expensive, and accordingly increase the cost of the vehicle. With the development of optical imaging technology, the cost of auto-focus image capturing devices are becoming cheaper, so if we can use an auto-focus image capturing device for measuring the distance between vehicles, the cost of the safe following distance warning system for a vehicle will be cut down greatly.

What is needed, therefore, is a safe following distance warning system for a vehicle with an auto-focus image capturing device for automatically measuring a distance between vehicles.

### SUMMARY

In accordance with a present embodiment, a safe following distance warning system for a vehicle for warning a driver who is following a vehicle too closely includes a forward-looking image capturing unit, a speed sensor, a processor, and a warning output device. The forward-looking image capturing unit is disposed at the front of the vehicle for capturing images forward of the vehicle. The forward-looking image capturing unit includes a taking lens, an image sensor disposed behind the taking lens, an image processing unit, and a lens driving unit. The image sensor is configured for converting an optical signal into an electrical signal. The image processing unit is configured for calculating an in-focus position of the taking lens. The lens driving unit is configured for driving the taking lens. The speed sensor is configured for sensing a current speed of the vehicle and outputting a speed signal representing the current speed of the vehicle. The processor is configured for calculating a following distance from the vehicle to a vehicle directly forward of the vehicle by using an image distance and a focal length of the taking lens received from the forward-looking image capturing unit at intervals and comparing the following distance to applicable safe distance parameters. The warning output device is configured for outputting an alarm to the driver of the vehicle when the following distance is less than the applicable safe distance parameter.

### BRIEF DESCRIPTION OF THE DRAWING

Many aspects of the present safe following distance warning system for a vehicle can be better understood with reference to the following drawings. The components in the drawing are not necessarily drawn to scale, the emphasis instead being placed upon clearly illustrating the principles of the present safe following distance warning system for a vehicle. Moreover, in the drawings, like reference numerals designate corresponding parts throughout the several views.

FIG. 1 is a schematic, functional block diagram of a safe following distance warning system for a vehicle according to a first embodiment.

FIG. 2 is a schematic, functional block diagram of a safe following distance warning system for a vehicle according to a second embodiment.

FIG. 3 is a flow chart of a safe following distance warning method for a vehicle according to a present embodiment.

### DETAILED DESCRIPTION OF THE EMBODIMENTS

Embodiments will now be described in detail below, with reference to the drawings.

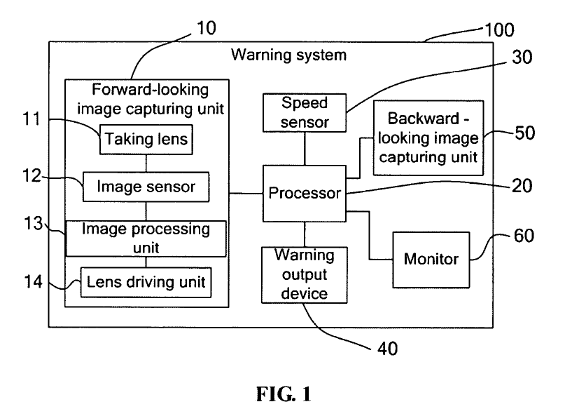

Referring to FIG. 1, a safe following distance warning system 100 for a vehicle according to a first embodiment is shown. The warning system 100 is configured for warning a driver of the vehicle when following a vehicle too closely. The warning system 100 includes a forward-looking image capturing unit 10, a processor 20, a speed sensor 30, and a warning output device 40. The image capturing unit 10 is disposed at the front of the vehicle.

The image capturing unit 10 is configured for capturing images forward of the vehicle. In the following, we name the vehicle assembled with the safe following distance warning system 100 as the present vehicle. The image capturing unit 10 includes a taking lens 11, an image sensor 12 disposed behind the taking lens 11, an image processing unit 13, and a lens driving unit 14. The image sensor 12 is configured for converting an optical signal into an electrical signal. The image processing unit 13 is configured for calculating an in-focus position of the taking lens 11. The lens driving unit 14 is configured for driving the taking lens 11 when needed. The forward-looking image capturing unit 10 sends an image distance and a focal length of the taking lens 11 to the processor 20 at intervals. The image distance is equal to the distance from the taking lens 11 to the image sensor 12 when the taking lens 11 is at an in-focus position.

The processor 20 is electrically connected to the image capturing unit 10 and configured for calculating a following distance from the present vehicle to a followed vehicle with the image distance and the focal length of the taking lens 11 received from the image capturing unit 10 at intervals. Then, the processor 20 compares the following distance to an applicable safe distance parameter. The applicable safe distance parameter is associated with braking distance at a current speed of the present vehicle, a driver reaction time, and may further include other refinements to the calculations to account for factors such as wet or icy road conditions. In the first embodiment, the applicable safe distance parameter is calculated by adding the product of a current speed of the present vehicle and a preset driver reaction time to a braking distance of the present vehicle at a current speed. The processor 20 sends a signal to the warning output device 40 when the following distance is less than the applicable safe distance parameter.

The speed sensor 30 is configured for sensing a current speed of the present vehicle and sending it to the processor 20.

The warning output device 40 is configured for outputting a warning signal to alert the driver of the present vehicle when the following distance is less than the applicable safe distance parameter. The warning output device 40 can be a sound generating device, such as a speaker or a microphone, for generating an audio alarm, or a monitor for displaying a visual alarm and so on.

In the first embodiment, the warning system 100 further includes a backward-looking image capturing unit 50 and a monitor 60. The image capturing unit 50 is disposed at the back of the present vehicle for providing the driver of the present vehicle a clear rear view. The monitor 60 is configured for displaying the rear view provided by the image capturing unit 50 to the driver of the present vehicle.

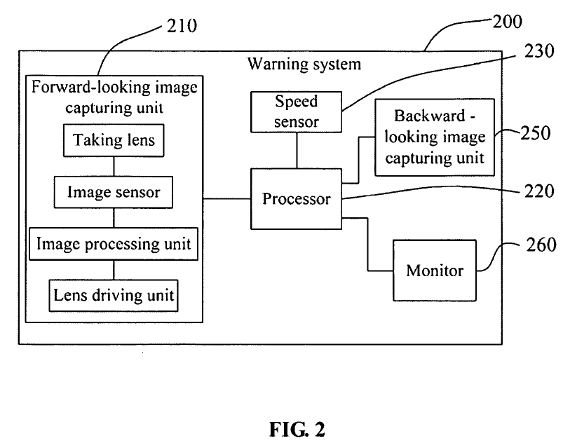

Referring to FIG. 2, a safe following distance warning system 200 for a vehicle according to a second embodiment is shown. The warning system 200 includes a forward-looking image capturing unit 210, a processor 220, a speed sensor 230, a backward-looking image capturing unit 250, and a monitor 260. The difference between the warning system 200 and the warning system 100 is that the monitor 260 not only can be used for displaying the rear view provided by the image capturing unit 250 but also can be used for outputting a warning signal to alert the driver of the present vehicle.

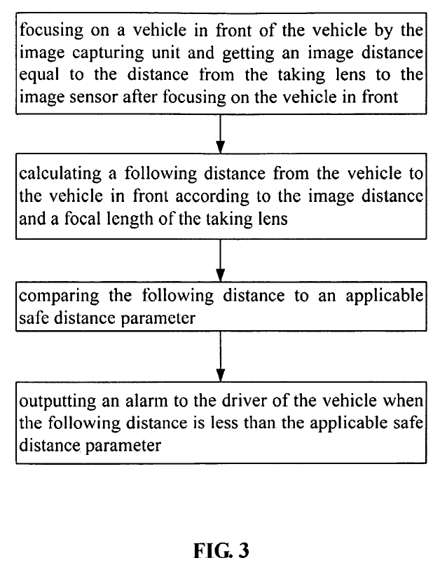

Referring to FIG. 3, a safe following distance warning method for a vehicle is also provided. The method alerts a driver of the vehicle when a following distance behind another vehicle is less than required for safety. The method includes the steps of: focusing on a vehicle in front of the vehicle by the image capturing unit 10 and getting an image distance equal to the distance from the taking lens 11 to the image sensor 12 after focusing on the vehicle in front; calculating a following distance from the vehicle to the vehicle in front according to the image distance and a focal length of the taking lens 11; comparing the following distance to an applicable safe distance parameter; outputting an alarm to the driver of the vehicle when the following distance is less than the applicable safe distance parameter.

The method of comparing the following distance to an applicable safe distance parameter further includes a step of: calculating the applicable safe distance parameter by adding the product of a current speed of the present vehicle and a preset driver reaction time to a braking distance of the present vehicle at a current speed.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A safe following distance warning system for a vehicle, the system being configured for warning a driver who is following a vehicle too closely, comprising:
a forward-looking image capturing unit disposed at the front of the vehicle for capturing images forward of the vehicle, the forward-looking image capturing unit comprising:
a taking lens;
an image sensor disposed behind the taking lens for converting an optical signal into an electrical signal;
an image processing unit for calculating an in-focus position of the taking lens; and
a lens driving unit for driving the taking lens;
a speed sensor for sensing a current speed of the vehicle and outputting a speed signal representing the current speed of the vehicle;
a processor for calculating a following distance from the vehicle to a vehicle directly forward of the vehicle by using an image distance and a focal length of the taking lens received from the forward-looking image capturing unit at intervals, the image distance being equal to the distance from the taking lens to the image sensor when the taking lens is at an in-focus position, the processor further able to compare the following distance to an applicable safe distance parameter; and
a warning output device for outputting an alarm to the driver of the vehicle when the following distance is less than the applicable safe distance parameter.

2. The system as claimed in claim 1, wherein the applicable safe distance parameter is calculated by adding the product of a current speed of the vehicle and a preset driver reaction time to a braking distance of the vehicle at a current speed.

3. The system as claimed in claim 1, wherein the warning output device is selected from a group consisting of a sound generating device, or a monitor.

4. The system as claimed in claim 1, wherein the alarm outputting from the warning output device is selected from a group consisting of an audio alarm, or a visual alarm.

5. The system as claimed in claim 1, comprising a backward-looking image capturing unit and a monitor, the backward-looking image capturing unit disposed at the back of the present vehicle for providing the driver of the present vehicle with a clear rear view, the monitor for displaying the rear view provided by the image capturing unit to the driver of the vehicle.

6. The system as claimed in claim 1, comprising a backward-looking image capturing unit disposed at the back of the present vehicle for providing the driver of the present vehicle with a clear rear view, the warning output device being a monitor for displaying the rear view provided by the image capturing unit to the driver of the vehicle.

7. A safe following distance warning method for a vehicle for warning a driver of the vehicle when following a vehicle too closely, the vehicle comprising an image capturing unit disposed at the front of the vehicle, the image capturing unit comprising a taking lens and an image sensor, comprising:
focusing on a vehicle in front of the vehicle by the image capturing unit and getting an image distance equal to the distance from the taking lens to the image sensor after focusing on the vehicle in front;
calculating a following distance from the vehicle to the vehicle in front according to the image distance and a focal length of the taking lens;
comparing the following distance to an applicable safe distance parameter; and
outputting an alarm to the driver of the vehicle when the following distance is less than the applicable safe distance parameter.

8. The method as claimed in claim 7, wherein the method of comparing the following distance to an applicable safe distance parameter further comprises a step of calculating the applicable safe distance parameter by adding the product of a current speed of the vehicle and a preset driver reaction time to a braking distance of the vehicle at a current speed.
